(19) United States
(12) Patent Application Publication
(10) Pub. No.: US 2006/0205879 A1
(43) Pub. Date: Sep. 14, 2006

(54) Film-forming composition and insulating film and electronic device using the same

(75) Inventors: Yutaka Adegawa, Haibara-gun (JP); Akira Asano, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/374,162

(22) Filed: Mar. 14, 2006

(30) Foreign Application Priority Data
Mar. 14, 2005 (JP) P.2005-071074
Aug. 29, 2005 (JP) P.2005-247944

(51) Int. Cl. C08L 71/12

(52) U.S. Cl. 525/132

(57) ABSTRACT

A film-forming composition contains a compound having a cage structure, wherein the film-forming composition has a content of each metal of 300 ppb or less, and an insulating film and an electronic device using the same.

### BACKGROUND OF THE INVENTION

1. Field of the Invention

This invention relates to a film-forming composition. More precisely, it relates to a composition for forming insulating films to be used in electronic devices and so on which are excellent in film properties such as dielectric constant and mechanical strength and an electronic device having an insulating film obtained by using this composition.

2. Background Art

In recent years, accompanied by the progress of high integration, multifunction and high performance in the field of electronic materials, circuit resistance and condenser capacity between wirings have been increased thus causing increase of electric power consumption and delay time. Particularly, increase of delay time becomes a large factor for the reduction of signal speed of devices and generation of crosstalk, so that reduction of parasitic resistance and parasitic capacity are in demand for the purpose of attaining acceleration of devices by reducing this delay time. As one of the concrete measures for reducing this parasitic capacity, an attempt has been made to cover periphery of wiring with a low dielectric interlayer insulating film. Also, such an interlayer insulating film is expected to have superior heat resistance which can withstand the thin film formation step at the time of mounting substrate production and chip connection, pin attachment and the like post steps and also chemical resistance that can withstand wet process. In addition, a low resistance Cu wiring has been introduced in recent years instead of the Al wiring, and accompanied by this, flattening by CMP (chemical mechanical polishing) is commonly carried out, so that high mechanical strength which can withstand this process is in demand.

Polybenzoxazole and polyimide are widely known for insulating films of good heat resistance. However, since they contain a nitrogen atom of high polarity, they could not form films that are satisfactory in point of the necessary low level of dielectric constant, the water absorption property, the durability and the hydrolysis property.

In general, many organic polymers are poorly soluble in organic solvent, and a technique of preventing polymer deposition in coating solutions and preventing depositions in insulating films is an important theme in the art. To solve the problems, when the polymers are so modified that their main chain has a folded structure in order to have an increased solubility, then their glass transition point lowers and their heat resistance also lowers, and, after all, it is not easy to obtain polymers that satisfy both the intended properties and the solubility.

For an insulating film, a highly heat-resistant resin having a backbone structure (main chain) of polyarylene ether (U.S. Pat. No. 6,509,415) is known. However, it is desired to further lower the dielectric constant of the resin for realizing high-speed devices. It is desired not to make a film porous but to make the film have a bulk specific dielectric constant of 2.6 or less, more preferably 2.5 or less.

### SUMMARY OF THE INVENTION

It is an object of the invention to provide a film-forming composition for solving the problems as discussed above. More specifically speaking, it is an object of the invention to provide a composition for forming films to be used in electronic devices and so on which are excellent in film properties such as dielectric constant, mechanical strength, heat resistance, etc. and an insulating film (also referred to as a “dielectric film” and a “dielectric insulating film”, and these terms are not substantially distinguished) obtained by using this composition and an electronic device having the insulating film. In particular, it is an object of the invention to provide a composition whereby a stable film can be formed without a decrease in the film thickness due to the decomposition or shrinkage of the formed insulating film even though repeatedly heated in the process of fabricating the device.

It has been found out that the above problems can be solved by the following constitutions item 1 to item 13.

Item 1

A film-forming composition comprising a compound having a cage structure, wherein the film-forming composition has a content of each metal of 300 ppb or less.

Item 2

A film-forming composition as described in the above item 1, wherein the content of each transition metal in the film-forming composition is 100 ppb or less.

Item 3

A film-forming composition as described in the above item 1, wherein the film-forming composition is obtained by a treatment of contacting with an ion exchange resin.

Item 4

A film-forming composition as described in the above item 3, wherein the ion exchange resin has a polyamine structure.

Item 5

A film-forming composition as described in the above item 1, wherein the cage structure is a saturated hydrocarbon structure.

Item 6

A film-forming composition as described in the above item 1, wherein a ratio of all carbon atoms of the cage structure to all carbon atoms of a total solid content of the film-forming composition is 30 % or more.

Item 7

A film-forming composition as described in the above item 1, wherein the cage structure is an adamantane structure.

Item 8

A film-forming composition as described in the above item 1, wherein the cage structure is a diamantane structure.

Item 9

A film-forming composition as described in the above item 8, wherein the compound having a cage structure is a polymer of at least one compound represented by a formula (I):

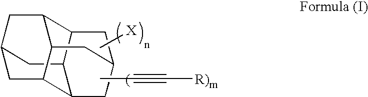

wherein R represents a hydrogen atom, an alkyl group having from 1 to 10 carbon atoms, an alkenyl group having from 2 to 10 carbon atoms, an alkynyl group having from 2 to 10 carbon atoms, an aryl group having from 6 to 20 carbon atoms or a silyl group having from 0 to 20 carbon atoms, and when a plurality of R's exist, they may be the same or different from each other; m represents an integer of 1 to 14; X represents a halogen atom, an alkyl group having from 1 to 10 carbon atoms, an alkenyl group having from 2 to 10 carbon atoms, an aryl group having from 6 to 20 carbon atoms or a silyl group having from 0 to 20 carbon atoms, and when a plurality of R's exist, they may be the same or different from each other; and n represents an integer of 0 to 13.

Item 10

A film-forming composition as described in the above item 1, wherein the compound having a cage structure is a compound that does not contain a nitrogen atom.

Item 11

A film-forming composition as described in the above item 1, wherein the film-forming composition contains an organic solvent.

Item 12

An insulating film formed from a film-forming composition as described in the above item 1.

Item 13

An electronic device comprising an insulating film as described in the above item 12.

An insulating film formed from the film-forming composition of the invention is excellent in film properties such as dielectric constant and mechanical strength and, in particular, in heat resistance. Owing to these characteristics, it is usable as an interlayer insulating film in electronic devices and so on.

### DESCRIPTION OF THE PREFERRED EMBODIMENT

A preferred embodiment of the invention will be explained below in detail.

Compound having Cage Structure

In the invention, “cage structure” is meant to indicate a molecule in which the plural rings formed of covalent-bonded atoms define the capacity of the structure and in which all points existing inside the capacity could not leave the capacity without passing through the rings. For example, an adamantane structure may be considered as the cage structure. Contrary to this, a cyclic structure having single-crosslink such as norbornane (bicyclo[2,2,l]heptane) could not be considered as the cage structure since the ring of the single-crosslinked cyclic compound does not define the capacity of the compound.

The content of each metal in the film-forming composition of the invention is 300 ppb or less, preferably 100 ppb or less and particularly preferably 1 ppb or less.

In particular, it is preferable that the content of each transition metal is 100 ppb or less, more preferably 10 ppb or less and particularly preferably 1 ppb or less.

Concerning transition metal species, it is preferable to lower the content of the transition metals of the group 8 and it is particularly preferable to lower the contents of rhodium, palladium, iron and nickel.

Concerning metal species other than transition metals, it is preferable to lower the contents of the metals of the groups 1A, 2A and 3B and it is particularly preferable to lower the contents of Na, Mg and Al.

The contents of individual metals can be lowered by performing treatments for lowering the contents of individual metals in the film-forming composition as will be mentioned hereinafter, performing treatments for lowering the contents of individual metals in media, or directly lowering the contents of individual metals from the composition.

Examples of the methods of the treatments for lowering the metal contents include multistage distillation, purification by sublimation, recrystallization, repeated treatments with ion exchange resins and filters made of them, especially careful prevention of the contamination with foreign matters compared with organic synthesis procedures commonly carried out in the art, a method of lowering metal contents with the use of chelate resins or filters made of them, and so on. A chelate resin is a product that is designed so that it can selectively adsorb and trap a specific ion species by taking advantage of the interaction between a specific chemical species (ligand) due to a coordination bond to form a complex. Examples thereof include DIAION CR20 (a chelate resin composed of a porous crosslinked styrene base bonded to polyamine group: MITSUBISHI CHEMICAL CO.), EPORAS MX-8 and MX-8C (iminopropionic acid type chelate resins: MORITEX CO.), AMBERLITE IRC748 (a chelate resin having styrene-divinylbenzene copolymer with iminodiacetic acid: ORGANO CO., LTD.), SUMICHELATE MC700 (an iminodiacetic acid resin: SUMITOMO CHEMICAL CO., LTD.), ACLEAN Z (ASAHI GLASS ENGINERRING CO., LTD.), CHELEX-100 (BIO-RAD LABORATORIES), DIAION CR-10 (MITSUBISHI CHEMICAL CO.), AMBERLIST 15DRY (ROHM AND HASS CO.), AMBERLIST 15WET (ROHM AND HASS CO.), AMBERLIST 15JWET (ROHM AND HASS CO.), AMBERLIST 16WET (ROHM AND HASS CO.), AMBERLIST 31WET (ROHM AND HASS CO.), AMBERLIST A21 (ROHM AND HASS CO.) and so on. Also, use may be made of adsorption by inorganic adsorbents. Examples thereof include mineral-based adsorbents such as white kieselgur and pentolite, graphite-based adsorbents such as active carbon and so on. It is also possible to employ commercially available Pd eliminators. Examples thereof include METAL SCAVENGER SI-Amine (SIGMA-ALDRICH CO.), METAL SCAVENGER SI-Diamine (SIGMA-ALDRICH CO.), METAL SCAVENGER SI-Triamine (SIGMA-ALDRICH CO.), METAL SCAVENGER SI-Thiol (SIGMA-ALDRICH CO.), METAL SCAVENGER SI-EDAB (SIGMA-ALDRICH CO.), METAL SCAVENGER SI-TAAcOH (SIGMA-ALDRICH CO.), METAL SCAVENGER SI-TAAcONa (SIGMA-ALDRICH CO.), METAL SCAVENGER SI-TBD (SIGMA-ALDRICH CO.), METAL SCAVENGER SI-Thiourea (SIGMA-ALDRICH CO.), METAL SCAVENGER Ethyldiaminetriacetic acid acetamide, polymer-bound (SIGMA-ALDRICH CO.), METAL SCAVENGER N,N,N′-Trimethylethylenediamine, polymer-bound (SIGMA-ALDRICH CO.), METAL SCAVENGER 6-Thionicotinamide, polymer bound (SIGMA-ALDRICH CO.), METAL SCAVENGER Bis[(diphenylphosphanyl)-methylamine, polymer-bound (SIGMA-ALDRICH CO.), METAL SCAVENGER 2-Mercaptoethylamine, polymer-bound (SIGMA-ALDRICH CO.), METAL SCAVENGER Bipyridine, polymer-bound (SIGMA-ALDRICH CO.) and so on. In addition, from the viewpoint of reducing alkali metal and alkali earth metal with transition metal, it is preferable that the ion exchange resin has the polyamine structure.

The number of all carbon atoms of the cage structure in the invention is preferably from 10 to 30, more preferably from 10 to 18, even more preferably from 10 to 14.

The carbon atoms that constitute the cage structure do not include the carbon atoms of the linking group and the substituent bonding to the cage structure. For example, 1-methyladamantane is composed of 10 carbon atoms, and 1-ethyldiamantane is composed of 14 carbon atoms.

Preferably, the cage structure in the invention is a saturated hydrocarbon. Preferred examples of the cage structure are diamond-like adamantanes, diamantanes, triamantanes, tetramantanes and dodecahedranes as having good heat resistance. Of those, diamantanes and triamantanes are still preferred; and diamantanes are particularly preferred as having a lower dielectric constant and being easy to produce.

The cage structure according to the invention may have one or more substituents, and examples of the substituents include a halogen atom (fluorine atom, chlorine atom, bromine atom or iodine atom), a straight, branched or cyclic alkyl group having from 1 to 10 carbon atoms (methyl, t-butyl, cyclopentyl, cyclohexyl or the like), an alkenyl group having from 2 to 10 carbon atoms (vinyl, propenyl or the like), an alkynyl group having from 2 to 10 carbon atoms (ethynyl, phenylethynyl or the like), an aryl group having from 6 to 20 carbon atoms (phenyl, 1-naphthyl, 2-naphthyl or the like), an acyl group having from 2 to 10 carbon atoms (benzoyl or the like), an aryloxy group having from 6 to 20 carbon atoms (phenoxy or the like), an arylsulfonyl group having from 6 to 20 carbon atoms (phenylsulfonyl or the like), nitro group, cyano group, a silyl group (triethoxysilyl, methyldiethoxysilyl, trivinylsilyl or the like) and the like. Further preferred substituents are fluorine atom, bromine atom, a straight, branched or cyclic alkyl group having from 1 to 5 carbon atoms, an alkenyl group having from 2 to 5 carbon atoms, an alkynyl group having from 2 to 5 carbon atoms and a silyl group. These substituents may be further substituted with other substituents.

Preferably, the cage structure according to the invention has 1 to 4 substituents, more preferably 2 or 3 substituents and particularly preferably 2 substituents. In such a case, the substituent bonded to the cage structure may be a mono- or more poly-valent substituent or a di- or more poly-valent linking group.

The “compound having a cage structure” of the invention may be either a low molecular weight compound or a high molecular weight compound (e.g., a polymer), but preferred is a polymer. When the compound having a cage structure is a polymer, its weight average molecular weight is preferably from 1,000 to 500,000, more preferably from 5,000 to 300,000, particularly preferably from 10,000 to 200,000. The polymer having a cage structure may be contained in the film-forming composition as a resin having a molecular weight distribution. When the compound having a cage structure is a low molecular weight compound, its molecular weight is preferably not more than 3,000, more preferably not more than 2,000, particularly preferably not more than 1,000.

The cage structure according to the invention may be incorporated into a polymer principal chain as a monovalent pendant group. As a desirable polymer principal chain to which a cage structure is bonded, conjugated and unsaturated bond chains such as poly(arylene), poly(arylene ether), poly(ether) and polyacetylene, polyethylene and the like can be exemplified, of which poly(arylene ether) and polyacetylene are particularly desirable with respect to a good heat resistance.

It is particularly desirable that the cage structure of the invention forms a part of a polymer principal chain. That is, when it forms a part of a polymer principal chain, it means that the polymer chain is cut off when the cage structure is removed from this polymer. In this embodiment, the cage structure is directly single-bonded or connected by an appropriate divalent linking group. Examples of the linking group include —C(R₁₁) (R₁₂)—, —C(R₁₃)═C(R₁₄)—, —C≡C—, an arylene group, —CO—, —O—, —SO₂—, —N(R₁₅)—, —Si(R₁₆) (R₁₇)— and a group as a combination thereof. In this case, R₁l to R₁₇ each independently represents a hydrogen atom, an alkyl group, an alkenyl group, an alkynyl group, an aryl group or an alkoxy group. These linking groups may be substituted with a substituent, and for example, the aforementioned substituents can be cited as preferred examples.

More preferred linking groups among them is —C(R₁₁) (R₁₂)—, —CH═CH—, —C≡C—, an arylene group, —O—, —Si(R₁₆) (R₁₇)— or a group as a combination thereof, and particularly preferred is —CH═CH—, —C—C—, —O—, —Si(R₁₆) (R₁₇)— or a group as a combination thereof.

The “compound having a cage structure” of the invention may contain one or two or more species of the cage structures in the molecule of the compound.

Specific examples of “the compound having a cage structure” of the invention are as follows. However, it is to be understood that the invention is not construed as being restricted thereto.

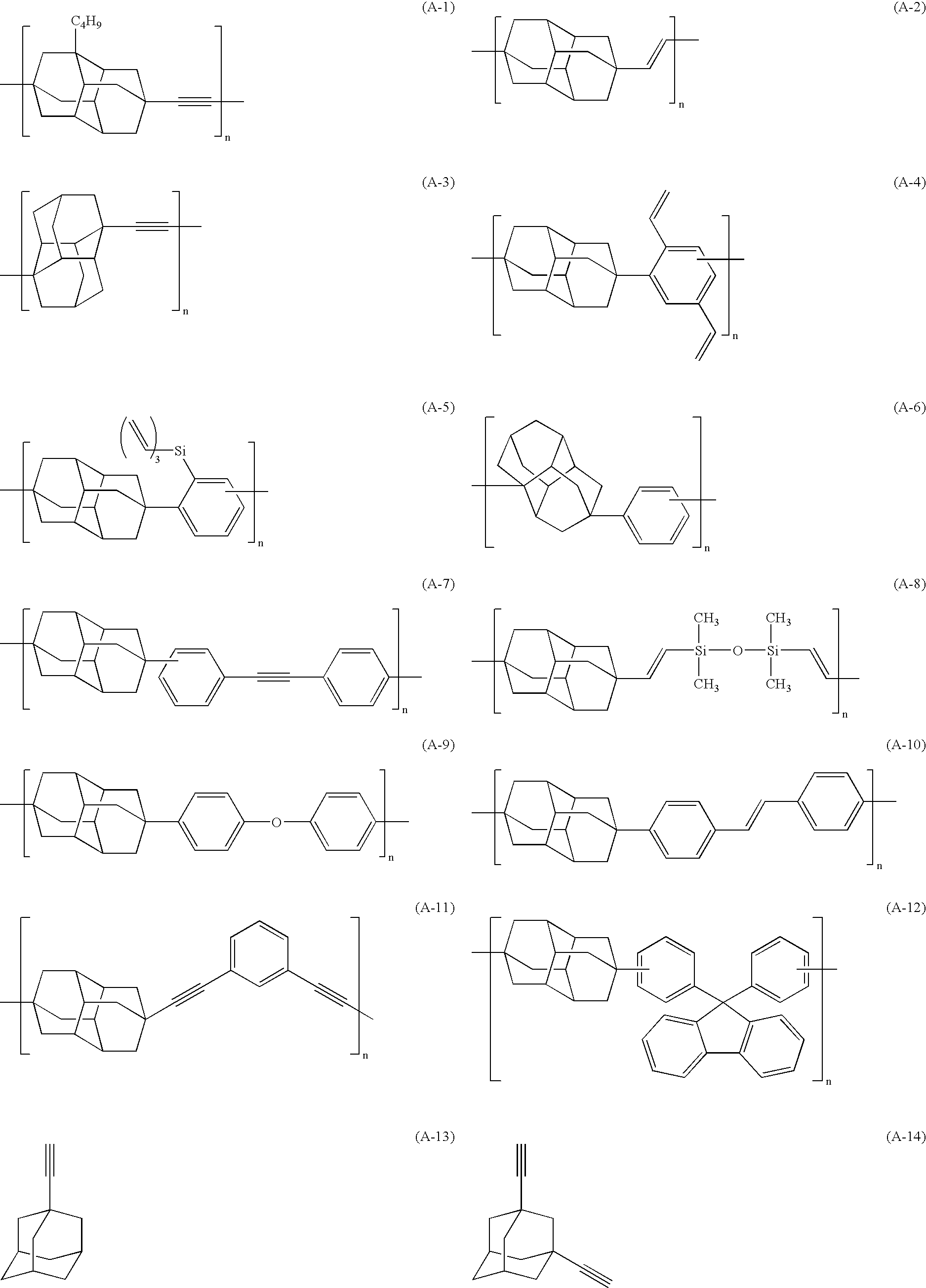

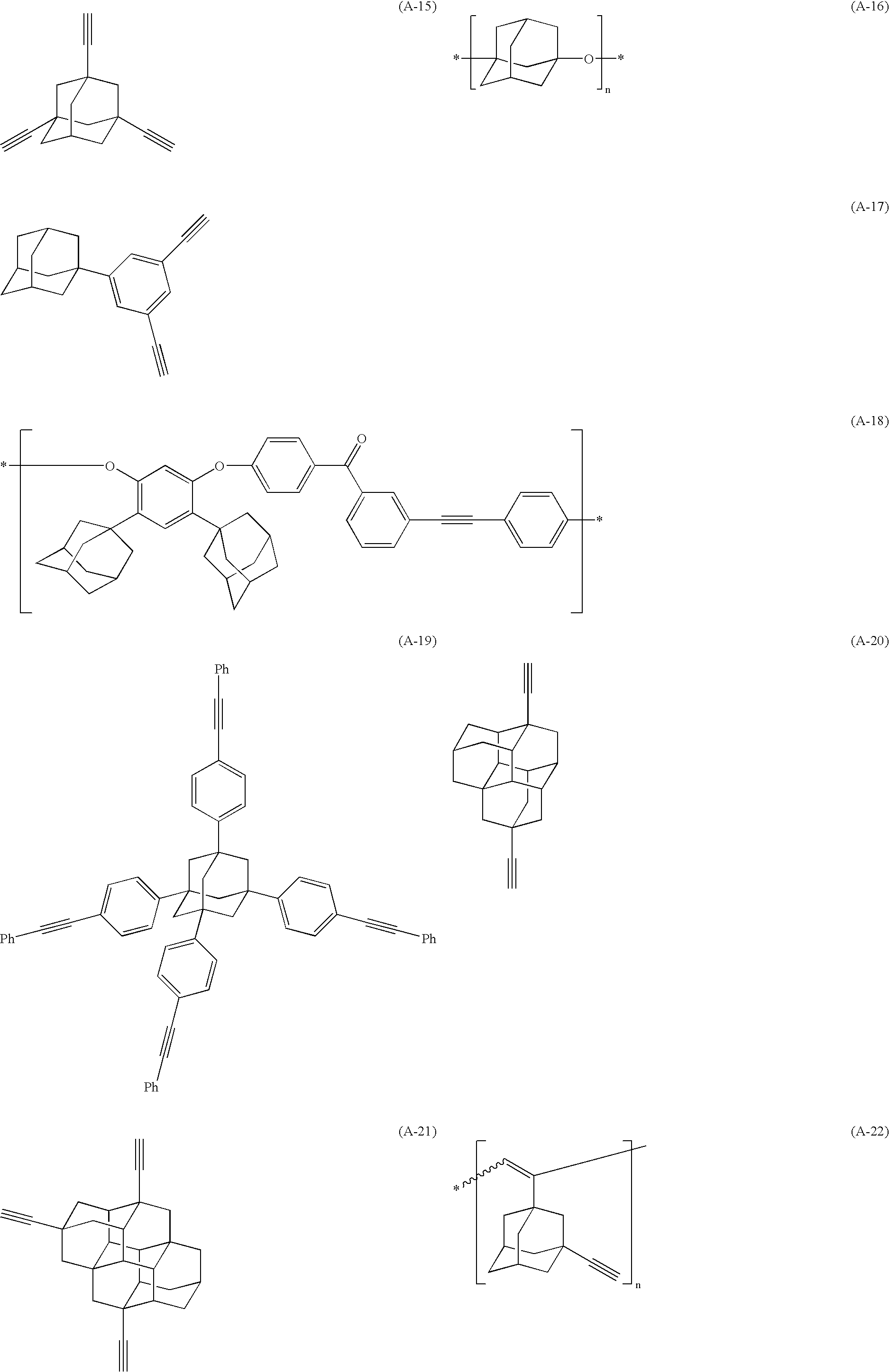

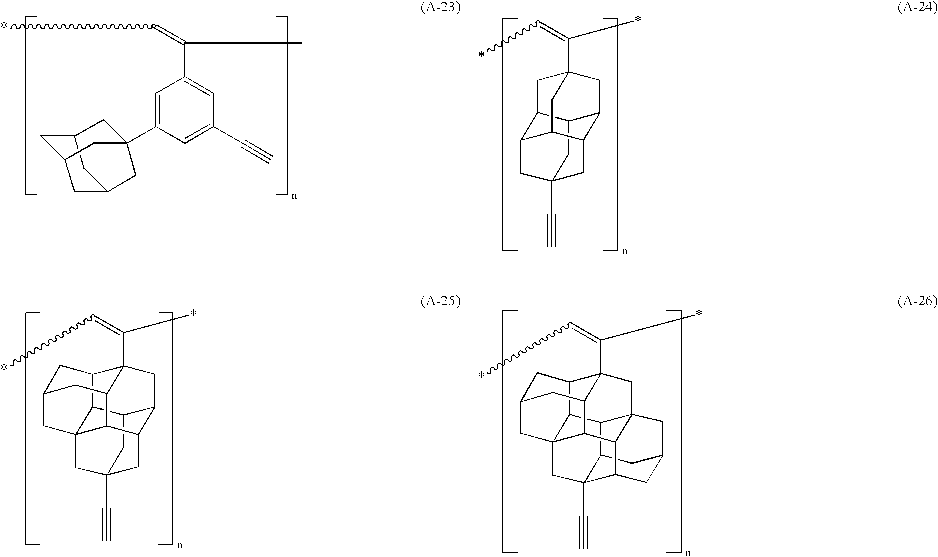

Especially preferably, the compound having a cage structure is a polymer of a compound of the following formula (I):

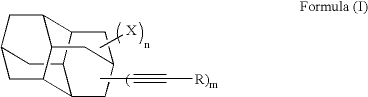

In the formula (I), R represents a hydrogen atom, an alkyl group having from 1 to 10 carbon atoms, an alkenyl group having from 2 to 10 carbon atoms, an alkynyl group having from 2 to 10 carbon atoms, an aryl group having from 6 to 20 carbon atoms, or a silyl group having from 0 to 20 carbon atoms, and when a plurality of R's exist, they may be the same or different from each other.

When R is other than a hydrogen atom, each group as R may has a substituent. Examples of the substituent include a halogen atom (fluorine atom, chlorine atom, bromine atom or iodine atom), an alkyl group, an alkenyl group, an alkynyl group, an aryl group, an acyl group, an aryloxy group, an arylsulfonyl group, a nitro group, a cyano group, a silyl group and the like. R is preferably a hydrogen atom, an alkyl group having from 1 to 10 carbon atoms, an aryl group having from 6 to 20 carbon atoms or a silyl group having from 0 to 20 carbon atoms, more preferably a hydrogen atom or a silyl group having from 0 to 10 carbon atoms.

The sign m is an integer of 1 to 14, preferably an integer of 1 to 4, more preferably an integer of 1 to 3, and particularly preferably 2 or 3.

X represents a halogen atom, an alkyl group having from 1 to 10 carbon atoms, an alkenyl group having from 2 to 10 carbon atoms, an aryl group having from 6 to 20 carbon atoms, or a silyl group having from 0 to 20 carbon atoms, and when a plurality of R's exist, they may be the same or different from each other. Each group as X may have a substituent wherein the aforementioned substituents can be cited as examples of the substituent. X is preferably a fluorine atom, a chlorine atom, a bromine atom, an alkyl group having from 1 to 10 carbon atoms, an alkenyl group having from 2 to 10 carbon atoms or a silyl group having from 0 to 20 carbon atoms, more preferably a bromine atom, an alkenyl group having from 2 to 4 carbon atoms or a silyl group having from 0 to 10 carbon atoms.

The sign n is an integer of 0 to 13, preferably an integer of 0 to 3, more preferably an integer of 0 to 2, particularly preferably 0 or 1.

Concerning the optimum polymerization conditions for the compound represented by the formula (I), the polymerization is carried out in an organic solvent preferably at an internal temperature of 0° C. to 220° C., more preferably 50° C. to 210° C. and particularly preferably 100° C. to 200° C., preferably for 1 to 50 hours, more preferably 2 to 20 hours and particularly preferably 3 to 10 hours. If desired, use may be made of a metal catalyst such as palladium, rhodium, nickel, tungsten, molybdenum or the like.

The weight-average molecular weight of the polymer thus polymerized preferably ranges from 1,000 to 500,000, more preferably from 5, 000 to 300, 000 and particularly preferably from 10,000 to 200,000.

Specific examples of the compound represented by the formula (I) are as follows.

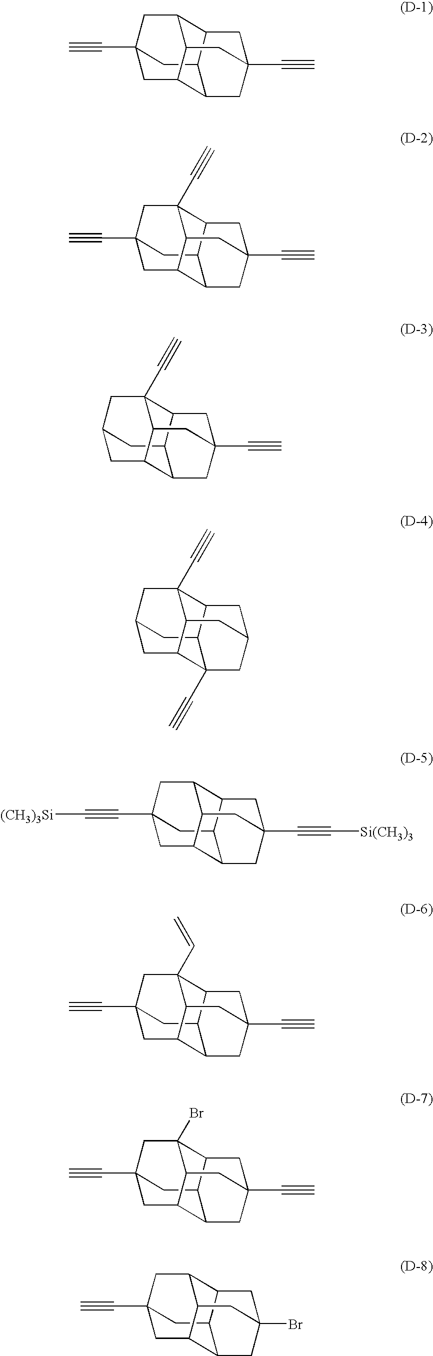

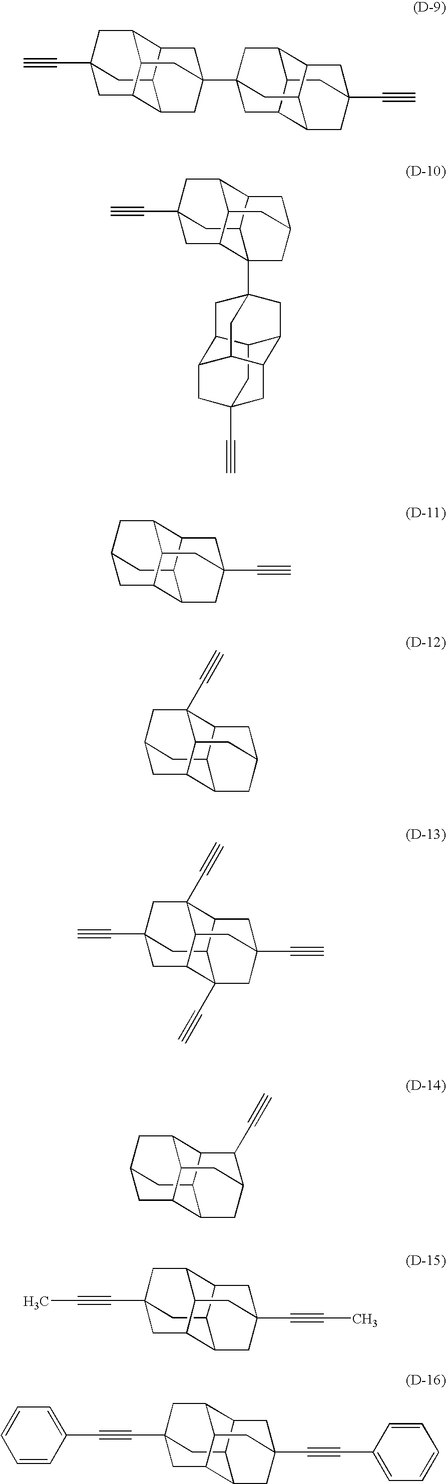

It is preferred that the compound of the invention has a reactive group capable of forming a covalent bond with any other molecule under heating. The reactive group is not specifically defined, for which, for example, preferred is a substituent that leads a cyclization-addition reaction or a radical polymerization reaction. For example, a double bond-having group (e.g., vinyl group, allyl group), a triple bond-having compound (e.g., ethynyl group, phenylethynyl group), and a combination of a diene group and a dienophile group to lead Diels-Alder reaction are effective. In particular, an ethynyl group and a phenylethynyl group are effective.

Preferably, the compound having a cage structure for use in the invention does not contain a nitrogen atom. This is because a nitrogen atom increases the molar polarizability of the compound, causes moisture absorption of insulating films and thus increases the dielectric constant. Therefore, the compound having a cage structure for use in the invention is preferably a compound except polyimide, i.e., a compound free from a polyimide bond or an amide bond.

From the viewpoint of imparting favorable properties (dielectric constant, mechanical strength) to insulating films formed from the composition of the invention, it is preferable that the ratio of all carbon atoms of the cage structure of the compound in the film-forming composition to all carbon atoms of the total solid content of the composition is 30% or more, more preferably from 50 to 95%, particularly preferably from 60 to 90%. The total solid content of the film-forming composition corresponds to the total solid content of the insulating film to be formed from a coating solution of the composition. Those not remaining in the insulating film formed from the composition, such as a foaming agent, should not be within the solid content.

As the composition having a cage structure of the invention, use may be made of a commercially available one. Alternatively, it is also possible to use a compound synthesized by a publicly known method.

The film-forming composition of the invention can be used in the form of a coating solution containing an organic solvent.

Although solvents suitably usable in the invention are not particularly limited, examples thereof include alcoholic solvents such as 1-methoxy-2-propanol, 1-butanol, 2-ethoxymethanol and 3-methoxypropanol; ketone solvents such as acetylacetone, methyl ethyl ketone, methyl isobutyl ketone, 2-pentanone, 3-pentanone, 2-heptanone, 3-heptanone and cyclohexanone; ester solvents such as propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrol; aromatic hydrocarbon solvents such as mesitylene, ethylbenzene, diethylbenzene, propylbenzene and 1,2-dichlorobenzene; and so on. Either one of these solvents or a mixture of two or more of them may be used.

More preferred solvents are 1-emthoxy-2-propanol, cyclohexanone, propylene glycol monomethyl ether acetate, ethyl lactate, y-butyrolactone, anisole and mesitylene.

The total solid concentration of a coating solution according to the invention is preferably from 3 to 50% by mass, more preferably from 5 to 35% by mass, particularly preferably from 7 to 20% by mass.

The film-forming composition of the invention may contain any additives such as a radical generator, a nonionic surfactant, a fluorine-based ionic surfactant and a silane-coupling agent added thereto, so long as the various properties (e.g., heat resistance, dielectric constant, mechanical strength, coatability, adhesiveness, etc.) of the insulating film to be formed from the composition are not deteriorated thereby.

The radical generator includes, for example, t-butyl peroxide, pentyl peroxide, hexyl peroxide, lauroyl peroxide, benzoyl peroxide, azobisisobutyronitrile and so on. The nonionic surfactant includes, for example, octylpolyethylene oxide, decylpolyethylene oxide, dodecylpolyethylene oxide, octylpolypropylene oxide, decylpolypropylene oxide, dodecylpolypropylene oxide and so on. The fluorine-based nonionic surfactant includes, for example, perfluorooctylpolyethylene oxide, perfluorodecylpolyethylene oxide, perfluorododecylpolyethylene oxide and so on. The silane-coupling agent includes, for example, vinyltrimethoxysilane, vinyltriethoxysilane, vinyltriacetoxysilane, allyltrimethoxysilane, allyltriethoxysilane, divinyldiethoxysilane, trivinylethoxysilane, their hydrolyzates and dehydrated condensates and so on.

The suitable range of the amount of such an additive in the composition varies depending on the use of the additive and the solid concentration of the film-forming composition. In general, the total amount of all additives in the composition may be preferably from 0.001 to 10% by mass, more preferably from 0.01 to 5% by mass, particularly preferably from 0.05 to 2% by mass relative to the total amount of the film-forming composition.

An insulating film may be formed by applying the coating solution of the invention onto a substrate in any desired method such as the spin coating method, the roller coating method, the dip coating method, or the scan coating method, and then heating it to remove the solvent. The heating method is not specifically defined. Namely, use may be made therefor of any method commonly employed in the art, for example, a method of using a hot plate or a heating furnace, a method of photoirradiation with a xenon lamp for RTP (rapid thermal processor) or the like.

After the heat treatment as described above, the film may be aged by heating. This step is referred to as the baking step (or the thermal aging step). A baking step means a step involving a heating treatment at 300° C. or higher. It is also possible to continuously perform the heat drying step and the baking step. In the present invention, the continuous heating falls within the category of the heat drying step. The heating method is not specifically defined. Namely, use may be made therefor of any method commonly employed in the art, for example, a method of using a hot plate or a heating furnace, a method of photoirradiation with a xenon lamp for RTP (rapid thermal processor) or the like.

The insulating film obtained by using the coating solution of the invention is suitable for an insulation-coating film in electronic parts such as semiconductor devices, multi-chip module multilayered wiring boards, etc. Specifically, it is usable as an interlayer insulating film for semiconductors, a surface protective film, a buffer coat film, as well as for a passivation film in LSI, an α-ray blocking film, a cover lay film in flexographic plates, an overcoat film, a cover coat for flexible copper-lined plates, a solder-resist film, a liquid-crystal alignment film, etc.

Although the thickness of the coating film are not particularly limited, thickness thereof is preferably from 0.001 to 100 μm, more preferably from 0.01 to 10 μm, particularly preferably from 0.1 to 1 μm.

It is also possible to preliminarily add a foaming agent to the coating solution for forming the insulating film of the invention to thereby form a porous film. Although the foaming agent to be used for forming a porous film is not particularly restricted, examples thereof include organic compounds having a higher boiling point than the solvent in the coating solution, heat-degradable low-molecular weight compounds, heat-degradable polymers and so on.

The appropriate amount of the foaming agent to be added varies depending on the solid content of the coating solution. In general, it is employed preferably in an amount of 0.01 to 20% by mass, more preferably 0.1 to 10% by mass, particularly preferably 0.5 to 5% by mass in the coating solution.

After coated, it is preferable to heat the substrate so that the compound of the invention is crosslinked to give an insulating film having good mechanical strength and heat resistance. The optimum condition for the heat treatment is as follows: The heating temperature is preferably from 200 to 450° C., more preferably from 300 to 420° C., particularly preferably from 350 to 400° C.; and the heating time is preferably from 1 minute to 2 hours, more preferably from 10 minutes to 1.5 hours, even more preferably from 30 minutes to 1 hour. The heat treatment may be carried out in a few stages.

### EXAMPLE

The following Examples are to describe the invention but not to restrict the scope of the invention.

The structures of the compounds employed in Examples are as follows.

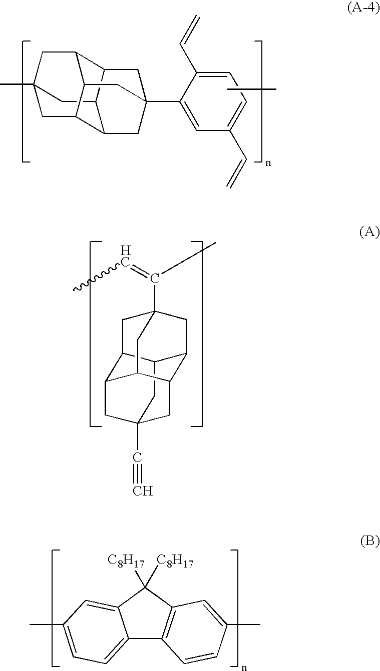

### Synthesis Example 1

According to the method described in Macromolecules, 24, 5266 (1991), 4,9-dibromodiamantane was synthesized. Next, 1.30 g of commercially-available p-divinylbenzene, 3.46 g of 4,9-dibromodiamantane, 200 ml of dichloroethane and 2.66 g of aluminum chloride, in which the Fe content had been lowered to 1 ppb or less by repeating careful purification by sublimation 10 times, were fed into a 500-ml flask, and stirred at an internal temperature of 70° C. for 24 hours. Next, 200 ml of water was added to it, and the organic layer was separated through liquid-liquid separation. Anhydrous sodium sulfate was added to it, and the solid matters were removed through filtration. Then, the residue was concentrated under reduced pressure until dichloromethane was halved. 300 ml of methanol was added to the resulting solution, and the precipitate thus formed was taken out through filtration. 2.8 g of a polymer (A-4) having a weight-average molecular weight of about 10000 was thus obtained.

In the same manner, a polymer (A-12) having a weight-average molecular weight of about 10000 was synthesized through Friedel-Crafts reaction.

### Example 1

1.0 g of the above polymer (A-4) was dissolved under heating in a mixed solvent of 5.0 ml of cyclohexanone and 5.0 ml of anisole to prepare a coating solution. The obtained solution was passed through an ion exchange resin (CR-20, manufactured by MITSUBISHI CHEMICAL CO.) 10 times. The resin had been preliminarily washed with acetone and PGME (propylene glycol monomethyl ether). The column size was 1.5 cm×10 cm (ECONOCOLUMN, manufactured by BIO-RAD LABORATORIES) and the amount of the resin employed was 7.5 ml. When the metal contents of the solution thus obtained were measured by the flameless atomic absorption spectrometry and the ICP-MS method, the Fe content was 1 ppb or less and the Al content was 290 ppb. This solution was filtered through a 0.1-micron tetrafluoroethylene filter, and then applied onto a silicon wafer by spin coating. The coating film was heated on a hot plate in a nitrogen stream at 150° C. for 60 seconds, then further on a hot plate at 400° C. for 30 minutes. The specific dielectric constant of the thus-formed insulating film having a thickness of 0.5 microns, which was calculated from the capacitance value thereof measured at 1 MHz by the use of Four Dimensions' mercury probe and Yokogawa Hewlett Packard's HP4285ALCR meter, was2.49. The Young's modulus of the film, which was measured by using MTS' nano-indenter SA2, was 7.3 GPa.

Next, this wafer was heated in a nitrogen atmosphere at 400° C. for 1 hour and then the film thickness was measured. As a result, the film thickness was 0.5 microns, i.e., being the same as the film thickness before the treatment (residual ratio of film: 100%).

### Synthesis Example 2

According to the method described in Macromolecules, 5262, 5266 (1991) with the use of diamantane as the starting material, 4,9-diethynyldiamantane was synthesized. Next, 10 g of 4,9-diethynyldiamantane and 50 ml of 1,3,5-triisopropylbenzene were mixed with PS-carrying Pd(PPh₃)₄ (120 mg in terms of Pd(PPh₃)₄) and the resultant mixture was stirred in a nitrogen stream at an internal temperature of 190° C. for 12 hours. The liquid reaction mixture was allowed to cool to room temperature and then 300 ml of isopropyl alcohol was added. The solid thus precipitated was filtered and washed with methanol. Thus, 3.0 g of a polymer (A) having a weight-average molecular weight of 20,000 was obtained.

### Example 2

1.0 g of the above polymer (A) synthesized in Synthesis Example 2 was dissolved in 10.0 mg of cyclohexanone to prepare a coating solution. When the metal contents of the solution thus obtained were measured by the flameless atomic absorption spectrometry and the ICP-MS method, the contents of metals including Pd and Al were all 1 ppb or less. This solution was filtered through a 0.2-micron tetrafluoroethylene filter, and then applied onto a silicon wafer by spin coating. The coating film was heated on a hot plate in a nitrogen stream at 110° C. for 90 seconds, then further on a hot plate at 250° C. for 60 seconds. Moreover, it was heated in a nitrogen-purged oven at 400° C. for 60 minutes. The specific dielectric constant of the thus-formed insulating film having a thickness of 0.50 microns was 2.40. The Young's modulus of the film was 7.1 GPa.

Next, this wafer was heated in a nitrogen atmosphere at 400° C. for 1 hour and then the film thickness was measured. As a result, the film thickness was 0.5 microns, i.e., being the same as the film thickness before the treatment.

### Synthesis Example 3

According to the method described in Macromolecules, 5262, 5266 (1991) with the use of diamantane as the starting material, 4,9-diethynyldiamantane was synthesized. Next, 10 g of 4,9-diethynyldiamantane and 50 ml of 1,3,5-triisopropylbenzene were mixed with Pd(PPh₃)₄ (120 mg in terms of Pd(PPh₃)₄) and the resultant mixture was stirred in a nitrogen stream at an internal temperature of 190° C. for 12 hours. The liquid reaction mixture was allowed to cool to room temperature and then 300 ml of isopropyl alcohol was added. The solid thus precipitated was filtered and washed with methanol. Thus, 3.0 g of a polymer (A) having a weight-average molecular weight of 20,000 was obtained.

### Example 3

1.0 g of the above polymer (A) synthesized in Synthesis Example 3 was dissolved in 10.0 mg of cyclohexanone to prepare a coating solution. The obtained solution was passed through an ion exchange resin (CR-20, manufactured by MITSUBISHI CHEMICAL CO.) 10 times. The resin had been preliminarily washed with acetone and PGME. The column size was 1.5 cm×10 cm (ECONOCOLUMN, manufactured by BIO-RAD LABORATORIES) and the amount of the resin employed was 7.5 ml. When the metal contents of the solution thus obtained were measured by the flameless atomic absorption spectrometry and the ICP-MS method, the contents of metals including Pd and Al were all 1 ppb or less. This solution was filtered through a 0.2-micron tetrafluoroethylene filter, and then applied onto a silicon wafer by spin coating. The coating film was heated on a hot plate in a nitrogen stream at 110° C. for 90 seconds, then further on a hot plate at 250° C. for 60 seconds. Moreover, it was heated in a nitrogen-purged oven at 400° C. for 60 minutes. The specific dielectric constant of the thus-formed insulating film having a thickness of 0.50 microns was2.40. The Young's modulus of the film was 7.1 GPa.

Next, this wafer was heated in a nitrogen atmosphere at 400° C. for 1 hour and then the film thickness was measured. As a result, the film thickness was 0.5 microns, i.e., being the same as the film thickness before the treatment.

### Comparative Example 1

The procedure of Example 1 was followed but omitting the purification by sublimation and the ion exchange resin treatment to give a solution. When the transition metal contents of the solution thus obtained were measured by the flameless atomic absorption spectrometry and the ICP-MS method, 150 ppb of Fe and 600 ppb of Al were detected. This solution was filtered through a 0.1-micron tetrafluoroethylene filter, and then applied onto a silicon wafer by spin coating. The coating film was heated on a hot plate in a nitrogen stream at 150° C. for 60 seconds, then further on a hot plate at 400° C. for 30 minutes. The specific dielectric constant of the thus-formed insulating film having a thickness of 0.5 microns, which was calculated from the capacitance value thereof measured at 1 MHz by the use of Four Dimensions' mercury probe and Yokogawa Hewlett Packard's HP4285ALCR meter, was 2.54. The Young's modulus of the film, which was measured by using MTS' nano-indenter SA2, was 7.0 GPa.

Next, this wafer was heated in a nitrogen atmosphere at 400° C. for 1 hour and then the film thickness was measured. As a result, the film thickness was 0.4 microns, i.e., amounting to 80% of the film thickness before the treatment.

### Comparative Example 2

The procedure of Example 1 was followed but omitting the ion exchange resin treatment to give a solution. When the transition metal contents of the solution thus obtained were measured by the flameless atomic absorption spectrometry and the ICP-MS method, 600 ppb of Al was detected. This solution was filtered through a 0.1-micron tetrafluoroethylene filter, and then applied onto a silicon wafer by spin coating. The coating film was heated on a hot plate in a nitrogen stream at 150° C. for 60 seconds, then further on a hot plate at 400° C. for 30 minutes. The specific dielectric constant of the thus-formed insulating film having a thickness of 0.5 microns, which was calculated from the capacitance value thereof measured at 1 MHz by the use of Four Dimensions' mercury probe and Yokogawa Hewlett Packard's HP4285ALCR meter, was 2.54. The Young's modulus of the film, which was measured by using MTS' nano-indenter SA2, was 7.0 GPa.

Next, this wafer was heated in a nitrogen atmosphere at 400° C. for 1 hour and then the film thickness was measured. As a result, the film thickness was 0.43 microns, i.e., amounting to 85% of the film thickness before the treatment.

### Example 4

A solution was prepared by the same procedure as in Comparative Example 1. Then the solution was passed through a chelate column (Chelex-100, dry mesh 100 to 200, exchange capacity 0.4 mer/mL, manufactured by BIO-RAD LABORATORIES) 10 times. The resin had been preliminarily washed with constant-boiling hydrochloric acid and water. The column size was 1.5 cm×10 cm (ECONOCOLUMN, manufactured by BIO-RAD LABORATORIES) and the amount of the resin employed was 7.5 mL. When the transition metal contents of the solution thus obtained were measured by the flameless atomic absorption spectrometry and the ICP-MS method, 15 ppb of Fe and 30 ppb of Al were detected. This solution was filtered through a 0.1-micron tetrafluoroethylene filter, and then applied onto a silicon wafer by spin coating. The coating film was heated on a hot plate in a nitrogen stream at 150° C. for 60 seconds, then further on a hot plate at 400° C. for 30 minutes. The specific dielectric constant of the thus-formed insulating film having a thickness of 0.5 microns, which was calculated from the capacitance value thereof measured at 1 MHz by the use of Four Dimensions' mercury probe and Yokogawa Hewlett Packard's HP4285ALCR meter, was 2.52. The Young's modulus of the film, which was measured by using MTS' nano-indenter SA2, was 7.1 GPa.

Next, this wafer was heated in a nitrogen atmosphere at 400° C. for 1 hour and then the film thickness was measured. As a result, the film thickness was 0.495 microns, i.e., amounting to 99% of the film thickness before the treatment.

### Comparative Example 3

1.0 g of a polymer (B) (obtained from SIGMA-ALDRICH CO.) was dissolved in 10.0 ml of cyclohexanone to prepare a coating solution. When the transition metal contents of the solution thus obtained were measured by the flameless atomic absorption spectrometry and the ICP-MS method, 150 ppb of Ni was detected. This solution was referred to as the solution B1. Next, this solution was passed through a chelate column (Chelex-100, dry mesh 100 to 200, exchange capacity 0.4 mer/mL, manufactured by BIO-RAD LABORATORIES) 10 times. The resin had been preliminarily washed with constant-boiling hydrochloric acid and water. The column size was 1.5 cm×10 cm (ECONOCOLUMN, manufactured by BIO-RAD LABORATORIES) and the amount of the resin employed was 7.5 ml. From the obtained solution, 15 ppb of Ni was detected. This solution was referred to as the solution B2. After individually filtering the solution B1 and the solution B2 through a 0.2-micron tetrafluoroethylene filter, these solutions were applied onto silicon wafers by spin coating. The coating films were heated on a hot plate in a nitrogen stream at 110° C. for 90 seconds, then further on a hot plate at 250° C. for 60 seconds. Moreover, they were heated in a nitrogen-purged oven at 400° C. for 60 minutes. The specific dielectric constants of the thus-formed insulating films having a thickness of 0.50 microns were each 2.70. The Young's moduli of the films were each 3.5 GPa.

Next, the wafer made form the solution B1 was heated in a nitrogen atmosphere at 400° C. for 1 hour and then the film thickness was measured. As a result, the film thickness was 0.45 microns, i.e., amounting to 90% of the film thickness before the treatment.

Next, the wafer made form the solution B2 was heated in a nitrogen atmosphere at 400° C. for 1 hour and then the film thickness was measured. As a result, the film thickness was 0.45 microns, i.e., amounting to 90% of the film thickness before the treatment.

TABLE 1

| | | Transition | Non-transition | Residual | specific | Young's |
|---|---|---|---|---|---|---|
| | | Metal content | metal content | ratio of | dielectric | modulus |
| | Polymer | (ppb) | (ppb) | film (%) | constant | (GPa) |
| Ex. 1 | A-4 | Fe:<1 | Al:290 | 100 | 2.49 | 7.3 |
| Ex. 2 | A | Pd:<1 | Al:<1 | 100 | 2.40 | 7.1 |
| Ex. 3 | A | Pd:<1 | Al:<1 | 100 | 2.40 | 7.1 |
| Ex. 4 | A-4 | Fe:15 | Al:30 | 99 | 2.52 | 7.1 |
| C.Ex. 1 | A-4 | Fe:150 | Al:600 | 80 | 2.54 | 7.0 |
| C.Ex. 2 | A-4 | Fe:<1 | Al:600 | 85 | 2.54 | 7.0 |
| C.Ex.3 B1 | B | Ni:150 | Al:<1 | 90 | 2.70 | 3.5 |
| C.Ex.3 B2 | B | Ni:15 | Al:<1 | 90 | 2.70 | 3.5 |

The present application claims the benefit of Japanese Patent Application (JP 2005-071074), filed in Japan on Mar. 14 of 2005, and Japanese Patent Application (JP 2005-247944), filed in Japan on Aug. 29 of 2005, the subject matter of which is hereby incorporated herein by reference.

What is claimed is:

1. A film-forming composition comprising a compound having a cage structure, wherein the film-forming composition has a content of each metal of 300 ppb or less.

2. A film-forming composition as claimed in claim 1, wherein the content of each transition metal in the film-forming composition is 100 ppb or less.

3. A film-forming composition as claimed in claim 1, wherein the film-forming composition is obtained by a treatment of contacting with an ion exchange resin.

4. A film-forming composition as claimed in claim 3, wherein the ion exchange resin has a polyamine structure.

5. A film-forming composition as claimed in claim 1, wherein the cage structure is a saturated hydrocarbon structure.

6. A film-forming composition as claimed in claim 1, wherein a ratio of all carbon atoms of the cage structure to all carbon atoms of a total solid content of the film-forming composition is 30% or more.

7. A film-forming composition as claimed in claim 1, wherein the cage structure is an adamantane structure.

8. A film-forming composition as claimed in claim 1, wherein the cage structure is a diamantane structure.

9. A film-forming composition as claimed in claim 8, wherein the compound having a cage structure is a polymer of at least one compound represented by a formula (I): 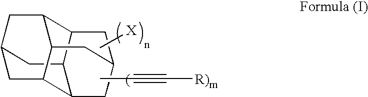
wherein R represents a hydrogen atom, an alkyl group having from 1 to 10 carbon atoms, an alkenyl group having from 2 to 10 carbon atoms, an alkynyl group having from 2 to 10 carbon atoms, an aryl group having from 6 to 20 carbon atoms or a silyl group having from 0 to 20 carbon atoms, and when a plurality of R's exist, they may be the same or different from each other; m represents an integer of 1 to 14; X represents a halogen atom, an alkyl group having from 1 to 10 carbon atoms, an alkenyl group having from 2 to 10 carbon atoms, an aryl group having from 6 to 20 carbon atoms or a silyl group having from 0 to 20 carbon atoms, and when a plurality of R's exist, they may be the same or different from each other; and n represents an integer of 0 to 13.

10. A film-forming composition as claimed in claim 1, wherein the compound having a cage structure is a compound that does not contain a nitrogen atom.

11. A film-forming composition as claimed in claim 1, wherein the film-forming composition contains an organic solvent.

12. An insulating film formed from a film-forming composition as claimed in claim 1.

13. An electronic device comprising an insulating film as claimed in claim 12.
